(19) United States
(12) Patent Application Publication
(10) Pub. No.: US 2026/0168831 A1
(43) Pub. Date: Jun. 18, 2026

(54) ULTRASONIC FLOW METER

(71) Applicant: BELIMO HOLDING AG, Hinwil (CH)

(72) Inventors: Patrick REISSNER, Herrliberg (CH); Sebastian ABEGG, Wetzikon (CH); Lucien BUCHMANN, Rapperswil (CH)

(73) Assignee: BELIMO HOLDING AG, Hinwil (CH)

(21) Appl. No.: 19/124,100

(22) PCT Filed: Nov. 1, 2023
(86) PCT No.: PCT/EP2023/080442

§ 371 Date: Apr. 24, 2025

(30) Foreign Application Priority Data
Nov. 3, 2022 (CH) CH001323/2022

(51) Int. Cl. G01F 1/667; G01F 1/66; G01F 1/663

(52) U.S. Cl. CPC G01F 1/668; G01F 1/66; G01F 1/663

(57) ABSTRACT

An ultrasonic flowmeter for measuring a flow of fluid through a channel includes a flowmeter body, and two or more ultrasonic transducers attached to the flowmeter body. The two or more ultrasonic transducers emit an ultrasonic pulse into the channel and receive an ultrasonic pulse in the channel and are arranged at a distance from each other in flow direction, when the flowmeter body is fixed to the channel. One or more ultrasonic transducer of the two or more ultrasonic transducers is attached to the flowmeter body by an acoustic decoupling element.

### FIELD OF THE DISCLOSURE

The present disclosure relates to an ultrasonic flow meter for measuring a fluid flow in HVAC systems.

### BACKGROUND OF THE DISCLOSURE

WO 2010/122117 A1 describes a ventilation system which draws air from an exterior of a building through a ventilation duct into an interior of the building. The ventilation system has an ultrasound sensor positioned in the ventilation duct upstream and/or downstream of the ventilator for measuring the volume flow. The ultrasound sensor of WO 2010/122117 A1 comprises a pair of ultrasonic transceivers which are mounted in a spaced apart relationship facing each other on opposing surfaces of the ventilation duct, emitting and receiving ultrasound waves in an angle of 60-90 degrees relative to the surface of the ventilation duct.

WO 2021/130307 A1 discloses an HVAC flow measurement system comprising an ultrasonic flowmeter for measuring a flow of fluid through a channel, the ultrasonic flowmeter comprising ultrasonic transducers arranged at a distance from each other in flow direction. The ultrasonic transducers are configured to emit an ultrasonic pulse into the channel and to receive an ultrasonic pulse in the channel. The HVAC flow measurement system is configured to measure the flow of fluid through a channel using not only the first reflected signal received, i.e. the signal which is reflected off the wall of the channel opposite to the ultrasonic transducers, but also using multiply reflected signals, in particular signals which have been reflected twice or three times off the channel walls before being received. A disadvantage of measuring the flow using multiply reflected signals is that the return signals from the singly reflected, doubly reflected and/or triply reflected signals can overlap each other making them difficult to distinguish.

### SUMMARY OF THE DISCLOSURE

It is an object of the disclosure and embodiments disclosed herein to provide an ultrasonic flow meter.

In particular, it is an object of the disclosure and embodiments disclosed herein to provide an ultrasonic flow meter which does not have at least some of the disadvantages of the prior art, in particular in that it allows for better distinguishing of singly reflected, doubly reflected and/or triply reflected measurement signals.

The present disclosure relates to ultrasonic flowmeter for measuring a flow of fluid through a channel. The ultrasonic flowmeter comprises a flowmeter body and at least two ultrasonic transducers attached to the flowmeter body. The ultrasonic transducers are configured to emit at least one ultrasonic pulse into the channel and to receive at least one ultrasonic pulse in the channel. What is meant by receiving an ultrasonic pulse in the channel is that the particular ultrasonic pulse that is received by the ultrasonic transducer is an ultrasonic pulse inside the channel which is incident on the ultrasonic transducer and thus received. The ultrasonic transducers are arranged at a distance from each other in flow direction, when the flowmeter body is fixed to the channel. At least one of the ultrasonic transducers is attached to the flowmeter body by way of an acoustic decoupling element.

The acoustic decoupling element is configured to attenuate acoustic signals passing through it, in particular passing from the flowmeter body through the acoustic decoupling element to the ultrasonic transducer, and vice versa (i.e. acoustic signals passing from the ultrasonic transducer through the acoustic decoupling element to the flowmeter body). The acoustic decoupling element is particularly configured to attenuate acoustic signals in the ultrasonic frequency range (i.e., with a frequency of 20 kHz and higher).

The acoustic decoupling element has the benefit of increasing the signal to noise ratio, in particular when a particular ultrasonic transducer is receiving an ultrasonic pulse from the channel (i.e. the particular ultrasonic transducer is in a measuring mode). This is because the ultrasonic pulses emitted by a first ultrasonic transducer into the channel are also coupled partially into the flowmeter body and travel through the flowmeter body to a second ultrasonic transducer receiving the ultrasonic pulse, leading to undesired noise. Depending on the embodiment, other undesired couplings are also possible, for example when the ultrasonic pulse is coupled directly through the flowmeter body between the ultrasonic transducers and/or coupled, via the flowmeter body, into a sidewall of the channel at a location close to the first ultrasonic transducer, and then coupled back out of the channel and into the flowmeter body at another location close to the second ultrasonic transducer, leading to further spurious signals.

The undesired noise caused by transmission through the flowmeter body and/or the channel side-wall typically arrives at the receiving ultrasonic transducer prior to the ultrasonic pulse reflected in the channel. Therefore, previously known mitigation techniques have included a time-filter, in which the receiving ultrasonic transducer filters out (i.e. ignores) signals received before an earliest anticipated arrival time of the ultrasonic pulse reflected in the channel and filters out signals received after a latest anticipated arrival time of the ultrasonic pulse. However, the time-filter has the significant disadvantage that only the most direct noise paths are thereby eliminated. More complex noise paths are possible (e.g., the ultrasonic pulse is coupled into the flowmeter body subsequent to a first reflection in the channel) which a time-filter does not eliminate.

This is of particular relevance for ultrasonic flowmeters which consider not only a single primary reflection off a back wall of the channel (i.e. the wall opposite the flowmeter), but consider also multiply reflected pulses. This is because the receiving ultrasonic transducer must “listen” for an extended period of time such that all ultrasonic pulses from all the multiple paths are received, and also because some of the received ultrasonic pulses will overlap each other, at least partially. The simple time-filter as explained above is, in such a scenario, of little use, as the time period of listening is much longer than for the simple case described above in which only a single reflected pulse is considered.

In an embodiment, the acoustic decoupling element has a cylindrical shape (e.g., at least partially a hollow cylindrical shape or sleeve shape) at least partially enclosing the ultrasonic transducer to which it is attached, and which ultrasonic transducer is attached to the flowmeter body by way of the acoustic decoupling element. The acoustic decoupling element can be made of any material suitable for the intended use of the flowmeter, in particular depending on the type of fluid in the channel.

Preferably, the acoustic decoupling element further acts as a gasket or sealing, preventing any fluid from leaking out of the channel and into the flowmeter through gaps between the flowmeter body and the ultrasonic transducers.

In an embodiment, there is at least one air gap between at least part of the particular acoustic decoupling element and the ultrasonic transducer. Alternatively or additionally, there is at least one air gap between at least part of the particular acoustic decoupling element and the flowmeter body. The air gap can be achieved by one or more protrusions as described herein. The air gap can be open to the channel or to the interior of the flowmeter body, or it can be closed, thereby forming an air pocket, either between the acoustic decoupling element and the ultrasonic transducer, or between the acoustic decoupling element and the flowmeter body.

Depending on the embodiment, the acoustic decoupling element includes a porous material and the one or more air gaps are formed by virtue of the porous material.

The air gaps have the advantage of providing another (additional) acoustic impedance transition, for example from the acoustic decoupling element to air, and vice versa, due to the acoustic decoupling element having a different acoustic impedance than air. This further serves to attenuate (i.e., dampen) the ultrasonic pulses traveling between the flowmeter body and the ultrasonic transducer.

In an embodiment, at least one of the acoustic decoupling elements includes protrusions on an inner surface of the particular acoustic decoupling element. The protrusions are for example arranged on the radial inner surface of the hollow cylindrical shaped acoustic decoupling element. Additionally, or alternatively, at least one of the acoustic decoupling elements includes protrusions on an outer surface of the particular acoustic decoupling element. The protrusions are for example arranged on the radial outer surface of the hollow cylindrical shaped acoustic decoupling element.

The protrusions are, for example, longitudinal ribs (on the inner and/or outer surface of the acoustic decoupling element) extending parallel to a cylinder axis of the ultrasonic transducer, the ultrasonic transducer having a cylindrical (preferably circular cylindrical) shape extending from a first end having a membrane to a second end. The protrusions are also, for example, transverse rings extending, for example in circumferential direction, around an inner or outer surface of the acoustic decoupling element. The protrusions are designed to couple the acoustic decoupling element to the ultrasonic transducer and/or couple the acoustic decoupling element to the flowmeter body.

In an embodiment, at least one of the acoustic decoupling elements comprises or is made of an elastomer or a thermoplastic or thermosetting polymer. For example, the elastomer is silicone. This has the added advantage of having a high acoustic impedance relative to the flowmeter body, which is typically injection molded from one or more thermoplastic or thermosetting polymers.

In an embodiment, the ultrasonic flowmeter includes a circuit board and at least one of the acoustic decoupling elements abuts against the circuit board. In particular, a first end of the acoustic decoupling element opposite a second end facing the channel abuts against the circuit board. This has the further benefit of acoustically isolating the ultrasonic transducer from the circuit board. Further, the second end may abut, at least in part, against the flowmeter body. Thereby, the acoustic decoupling element is held between the flowmeter body and the circuit board. In a further embodiment, the circuit board is coupled to the ultrasonic transducers only via the acoustic decoupling elements.

In an embodiment, the ultrasonic transducers extend out of the acoustic decoupling elements in direction of the channel. Advantageously, the ultrasonic transducers extend out of the acoustic decoupling elements in direction of the channel by at least 2 mm. More advantageously, the ultrasonic transducers extend out of the acoustic decoupling elements in direction of the channel by 2 mm-5 mm.

In an embodiment, the ultrasonic transducers is at least flush with an inner wall of the channel or extends into the direction of the channel. Advantageously, the ultrasonic transducers extend into the channel by 0 mm-5 mm. In an embodiment, the ultrasonic transducers have a symmetric polar radiation characteristic.

In an embodiment, the ultrasonic transducers have a central axis and at least one of the ultrasonic transducers has an asymmetric polar radiation characteristic with respect to the central axis to the transducer. An inner surface of the acoustic decoupling element may additionally be configured to cooperate with an outer surface of the particular ultrasonic transducer. An outer surface of the acoustic decoupling element is configured to cooperate with the flowmeter body, such that the ultrasonic transducer has a predefined polar angle with respect to the flowmeter body. Thereby, the ultrasonic transducer is readily oriented, during manufacture of the flowmeter in the correct manner. Depending on the embodiment, the asymmetrically radiating ultrasonic transducer may be installed such that, when installed in a channel, the radiation emitted away from the central axis of the transducer along a central axis of the channel is more relatively more pronounced than the radiation emitted away from the central axis of the transducer along a direction transverse to the central axis of the channel (or vice-versa).

In an embodiment, the flowmeter body comprises at least one sealing element arranged around at least one of the ultrasonic transducers, the sealing element configured to seal the ultrasonic flowmeter to the channel when the ultrasonic flowmeter is fixed to the channel. The sealing element is arranged on the flowmeter body around the ultrasonic transducer. The sealing element is preferably circular, for example an elastic ring-shaped seal set in an annulus-shaped recess of the flowmeter body.

In an embodiment, the sealing element comprises a gasket, for example a rubber gasket.

In an embodiment, the sealing element consists of a foam.

In an embodiment, the sealing element is an injection molded thermosetting or thermoplastic polymer, preferably co-molded with the flowmeter body.

In an embodiment, the ultrasonic transducers are arranged asymmetrically with respect to a transverse centerline of the flowmeter body. The ultrasonic transducers are thereby arranged such that the midpoint of a line between the ultrasonic transducers does not coincide with a center of the surface of the flowmeter body facing the channel. In particular, the midpoint is further upstream in flow direction than the center point.

In an embodiment, the flowmeter body comprises a housing with a substantially flat bottom wall with at least one opening for receiving, directly or by way of the acoustic decoupling element, the at least two ultrasonic transducers. The bottom wall is intended, when the flowmeter is installed, to face the channel through which the flow of fluid is measured. Preferably, there are at least two openings in the bottom wall for receiving each of the at least two ultrasonic transducers, directly or by way of at least one acoustic decoupling element. More preferably, there are at least two openings for receiving each of the at least two ultrasonic transducers by way of at least two acoustic decoupling elements. When the flowmeter is installed, the bottom wall preferably physically contacts the channel, for instance directly or by means of a sealing element arranged on an underside of the bottom wall. These embodiments have the advantage of allowing a simple assembly of the ultrasonic flowmeter, as the ultrasonic transducers and the flowmeter body are structurally integrated in a single unit and therefore only a single unit must be assembled during manufacture. This provides a further advantage of a simple and time-efficient installation of the flowmeter body on the channel, as only a single unit must be installed.

In an embodiment, the ultrasonic transducers have a shape with a substantially flat bottom surface. A central axis of each ultrasonic transducer is perpendicular to the bottom surface of the respective ultrasonic transducer. Preferably, the central axes of the ultrasonic transducers extend perpendicular to the bottom wall of the flowmeter body housing. Preferably, the central axes of the ultrasonic transducers are parallel to each other. These embodiments have the advantage of allowing a simple assembly and/or attachment of the ultrasonic transducers in a flowmeter body.

Alternatively, or in addition, the flowmeter body comprises a substantially rectangular cuboid housing with at least one opening for receiving the at least one ultrasonic transducer by way of an acoustic decoupling element. This embodiment also has the advantage of allowing a simple assembly and/or attachment of the ultrasonic flowmeter to a channel, as only a single unit must be assembled and installed.

Alternatively, or in addition, the flowmeter body comprises a housing with a main compartment formed by walls, including at least a bottom wall and a plurality of side-walls interconnected to the bottom wall, each side wall extending at an angle (e.g., perpendicular) from an edge of the bottom wall. The ultrasonic transducers are arranged inside the main compartment and at least one ultrasonic transducer is attached, by way of at least one acoustic decoupling element, to at least one opening of the bottom wall. When the flowmeter is installed, the bottom wall faces the channel through which the flow of fluid is measured. Preferably, two of the side walls are structurally interconnected to two opposing edges of the bottom wall, and the two side walls form, together with the bottom wall, a U-shaped structure around the main compartment. More preferably, the bottom wall is rectangular and four side walls are structurally interconnected to the four edges of the bottom wall and the four side walls form, together with the rectangular bottom wall, a basin structure which provides for or forms at least part of the main compartment. Preferably, the side walls and the bottom wall may be integrally formed. Preferably, the main compartment is hollow. These embodiments also have the advantage of allowing a simple manufacture of the flowmeter body.

Alternatively, or in addition, the bottom wall has at least one tubular extension which defines at least one ultrasonic transducer opening and extends, from a bottom wall of the flowmeter body, into a main compartment of the flowmeter body, each tubular extension configured to receive an ultrasonic transducer, wherein each ultrasonic transducer is at least partially sheathed inside an acoustic decoupling element arranged at least in part inside the tubular extension. Preferably, the tubular extension is arranged flush with the bottom wall. Preferably, the tubular extension extends only into the main compartment. Preferably, the tubular extension and the bottom wall are integrally formed, for example formed as a single injection molded part. Preferably, there are at least two tubular extensions, the two tubular extensions designed to house two ultrasonic transducers, respectively. Preferably, the ultrasonic transducers are at least partially sheathed inside two acoustic decoupling elements, respectively. The tubular extension may have a round, preferably a circular or an oval, cross-section. These embodiments have the advantage of allowing a simple manufacture of the flowmeter body and a simple assembly of the ultrasonic transducers.

Alternatively, or additionally, the at least one acoustic decoupling element separates the at least one ultrasonic transducer from the tubular extension, the acoustic decoupling element being an inset into the opening of the bottom wall, which opening is in turn configured to receive the ultrasonic transducer. Preferably, the acoustic decoupling element has a central axis substantially parallel to the central axis of the ultrasonic transducer. More preferably, the central axis of the acoustic decoupling element and the central axis of the respective ultrasonic transducer coincide.

Alternatively, or additionally, the acoustic decoupling element is tubular with a varying diameter and/or cross-sectional area. For example, the acoustic decoupling element has, along its central axis (which lies in the axial direction), at least two regions of different diameter and/or cross sectional area. In particular, the acoustic decoupling element has at least two regions of different internal diameter, external diameter, and/or wall thickness. Alternatively and/or additionally, the acoustic decoupling element has at least two regions of different inner cross-sectional area and/or external cross-sectional area, where the internal cross-sectional area is defined by an inner contour of the tubular acoustic decoupling element and the external cross-sectional area is defined by an external contour of the tubular acoustic decoupling element. Alternatively, or additionally, the acoustic decoupling element comprises steps of a substantially decreasing external cross section area and/or average distance of the external cross section from its central axis when moving along the central axis of the acoustic decoupling element from the upper end of the acoustic decoupling element towards the lower end of the acoustic decoupling element. The upper end is the end facing the main compartment and the lower end is the end at or near the bottom wall of the housing. Alternatively, or in addition, the acoustic decoupling element comprises at least one alignment element, which may be formed as one or more protrusions and/or one or more recesses. The alignment element may extend at least partially beyond the tubular extension in radial direction. The alignment element may extend inwardly on the upper end, extending at least partially into the central hollow area of the tubular shape of the acoustic decoupling element. Alternatively, or in addition, the acoustic decoupling element comprises a rim extending outwardly on the upper end, to abut the tubular extension. Alternatively, or in addition, the acoustic decoupling element comprises a rim extending inwardly on the upper end, to abut the ultrasonic transducer. These embodiments have the advantage of allowing a simple assembly of flowmeter body, acoustic decoupling element and ultrasonic transducers.

In an embodiment, the main compartment of the flowmeter body houses at least one circuit board and/or at least one electronic component. Preferably, the main compartment houses at least two circuit boards which are preferably arranged on top of each other. This allows for a sufficiently large total circuit board area for all necessary circuitry and electronic components while requiring a main compartment of a comparatively smaller footprint (i.e. two dimensional cross-sectional area) and/or overall volume when compared to arranging the circuitry on a single larger circuit board, thus also resulting in a flowmeter body having a comparatively smaller footprint and/or overall volume.

In an embodiment, the ultrasonic flowmeter further comprises a control module configured to determine and store transit times of ultrasonic pulses propagating in and against flow direction along more than one paths between the ultrasonic transducers. The control module is further configured to determine the flow of fluid using the transit times.

In addition to the flowmeter, the present disclosure also relates to a flow control system comprising a channel, a damper system having a damper flap arranged in the channel, and an ultrasonic flowmeter as described herein. The ultrasonic flowmeter is fixed to the channel and arranged upstream of the damper system.

In an embodiment, the flow control system further comprises a control module configured to determine and store transit times of ultrasonic pulses propagating in and against flow direction along more than one path in the channel. The flow control system is configured to determine the flow of fluid using the transit times.

In an embodiment, the control module is further configured to receive a flow setpoint and to control a damper actuator connected to the damper flap according to the flow setpoint and the determined flow of fluid. Thereby, the flow setpoint is reached, for example using a control loop.

In an embodiment, the control module is arranged in the damper system, in the ultrasonic flowmeter, or arranged as a separate device connected to the damper system and the ultrasonic flowmeter.

### BRIEF DESCRIPTION OF THE DRAWINGS

The herein described disclosure will be more fully understood from the detailed description given herein below and the accompanying drawings, which should not be considered limiting to the disclosure described in the appended claims. The drawings in which:

FIG. 1 shows a block diagram illustrating schematically a flowmeter having two ultrasonic transducers;

FIG. 2 shows a block diagram illustrating schematically a flow control system comprising a flowmeter, a channel, and a damper system;

FIG. 3 shows a block diagram illustrating schematically in a cross-sectional side view a channel for transporting a fluid having attached thereon an ultrasonic flowmeter and an optional damper system;

FIG. 4 shows a block diagram illustrating schematically in a cross-sectional top view a channel for transporting fluid having attached thereon an ultrasonic flowmeter with two reflection paths of ultrasonic pulses and an optional damper system;

FIG. 5 shows a block diagram illustrating schematically in a cross-sectional top view a channel for transporting fluid having attached thereon in an alternate arrangement an ultrasonic flowmeter with two reflection paths of ultrasonic pulses and an optional damper system;

FIG. 6 shows a block diagram illustrating schematically in a cross-sectional side view a flowmeter with two ultrasonic transducers, the ultrasonic transducers each being attached by way of an acoustic decoupling element;

FIG. 7a shows a block diagram illustrating schematically in a cross-sectional side view a section of a flowmeter in which a single ultrasonic transducer is depicted, the ultrasonic transducer having an acoustic decoupling element without air gaps and the ultrasonic transducer being flush with the acoustic decoupling element; and

FIG. 7b shows a block diagram illustrating schematically in a cross-sectional side view a section of a flowmeter in which a single ultrasonic transducer is depicted, ultrasonic transducer having a plurality of air gaps between the acoustic decoupling element and the ultrasonic transducer, and between the acoustic decoupling element and the flowmeter body, and the ultrasonic transducer being flush with the acoustic decoupling element;

FIG. 7c shows a block diagram illustrating schematically in a cross-sectional side view a section of a flowmeter in which a single ultrasonic transducer is depicted, the ultrasonic transducer having an acoustic decoupling element without air gaps and the ultrasonic transducer being extending out of the acoustic decoupling elements in direction of the channel; and

FIG. 7d shows a block diagram illustrating schematically in a cross-sectional side view a section of a flowmeter in which a single ultrasonic transducer is depicted, ultrasonic transducer having a plurality of air gaps between the acoustic decoupling element and the ultrasonic transducer, and between the acoustic decoupling element and the flowmeter body and the ultrasonic transducer being extending out of the acoustic decoupling elements in direction of the channel;

FIG. 8 shows a perspective view illustrating an acoustic decoupling element;

FIG. 9 shows a perspective view illustrating an ultrasonic transducer partially enclosed in an acoustic decoupling element; and

FIG. 10 shows a bottom view illustrating a flowmeter body with recesses for mounting ultrasonic transducers having acoustic decoupling elements; and

FIG. 11 shows the recorded signal of a transmitted signal of a certain amplitude at an exit angle of 0° from the ultrasonic transducers 11, 11A, 11B for two different relative extensions of the ultrasonic transducers 11, 11A, 11B from the acoustic decoupling elements 12, 12A, 12B, respectively.

### DESCRIPTION OF THE EMBODIMENTS

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

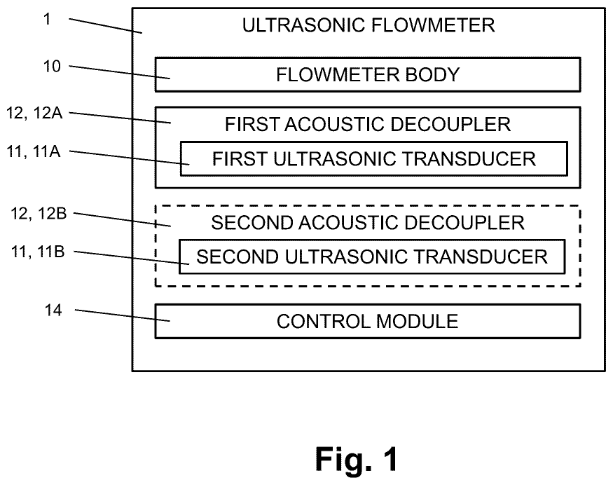

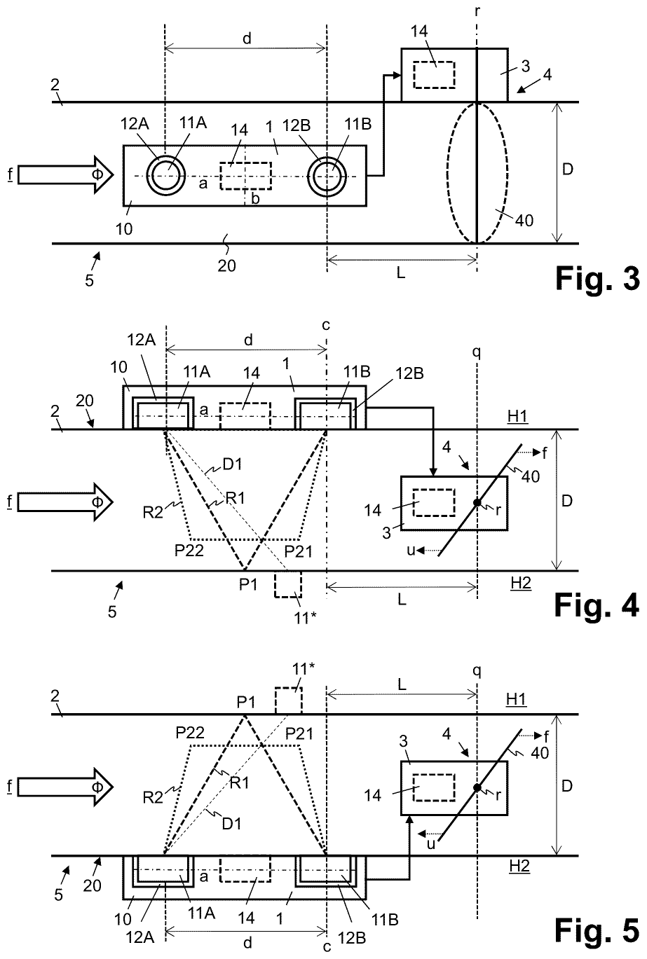

In FIGS. 1-5, reference numeral 1 refers to an ultrasonic flowmeter for measuring a flow Φ of fluid, e.g. air, through a channel 2; particularly, an HVAC ultrasonic flowmeter for heating, ventilating, and air conditioning (HVAC). The channel 2 is a gas (air) conduit, a gas (air) pipe, or a gas (air) entry passage, for example. The channel 2 has a cross-sectional profile of round, square or rectangular shape, for example. In the embodiments illustrated in FIGS. 3-6, the channel 2 has a round cross-sectional profile with a diameter D. The ultrasonic flowmeter 1 comprises one or more ultrasonic flowmeter units fixed to the channel 2, e.g. arranged on a wall of the channel 2. The ultrasonic flowmeter 1 comprises a flowmeter body 10 and at least two ultrasonic transducers 11, 11A, 11B, attached to the flowmeter body 10 and configured to emit an ultrasonic pulse into the channel 2 and to receive an ultrasonic pulse in the channel 2 along one or more paths, including direct paths (i.e. without any intermediate reflection), and/or reflection paths (i.e. via one or more reflection points).

In an embodiment, the ultrasonic flowmeter 1 includes two separate flowmeter units having separate flowmeter bodies 10, each having at least one ultrasonic transducer 11, 11A, 11B, the flowmeter units being electrically connected to each other.

As illustrated in FIGS. 3-5, the ultrasonic transducers 11, 11A, 11B are configured to receive at least one reflection of an ultrasonic pulse in the channel 2, specifically a reflection of an ultrasonic pulse on one or more reflection points P1, P21, P22, on an inside wall 20 of the channel 2 and propagating along a reflection path R1, R2, via the one or more reflection points P1, P21, P22. As illustrated in FIGS. 4 and 5, arranging one or more ultrasonic transducers 11, 11* on opposite walls of the channel 2 makes it possible to transmit and receive ultrasonic pulses via a direct path D1. The one or more ultrasonic transducers 11, 11* can also transmit and receive ultrasonic pulses via indirect paths, for example R3, in which the ultrasonic pulses are reflected once off the sidewall of the channel 2. As explained above, the one or more ultrasonic transducers 11, 11* on opposite walls of the channel 2 are preferably in a separate flowmeter unit having a separate flowmeter body 10.

As shown in FIGS. 1-8 and 10, the ultrasonic transducer(s) 11, 11A, 11B is arranged at least partially inside an acoustic decoupling element 12, 12A, 12B. The acoustic decoupling element 12, 12A, 12B is preferably designed to have a shape (for example, a cylindrical shape) which has a form fit around the ultrasonic transducer 11, 11A, 11B. In particular, the cylindrical shape of the acoustic decoupling element 12, 12A, 12B corresponds with the cylindrical shape of the ultrasonic transducer 11, 11A, 11B. More specifically, the acoustic decoupling element 12, 12A, 12B is designed such that an inner surface of the acoustic decoupling element 12, 12A, 12B achieves at least partially a form fit with an outer surface of the ultrasonic transducer 11, 11A, 11B. To be clear, the end of the ultrasonic transducer 11, 11A, 11B emitting or receiving the ultrasonic pulse from the channel is to be left at least partially unobstructed by the acoustic decoupling element 12, 12A, 12B.

Further, the acoustic decoupling element 12, 12A, 12B is preferably designed to have or to form at least partially a form fit with the flowmeter body 10. Thereby, the ultrasonic transducer 11, 11A, 11B is acoustically decoupled from the flowmeter body 10, as no part of the body of the ultrasonic transducer 11, 11A, 11B is in direct contact with the flowmeter body 10.

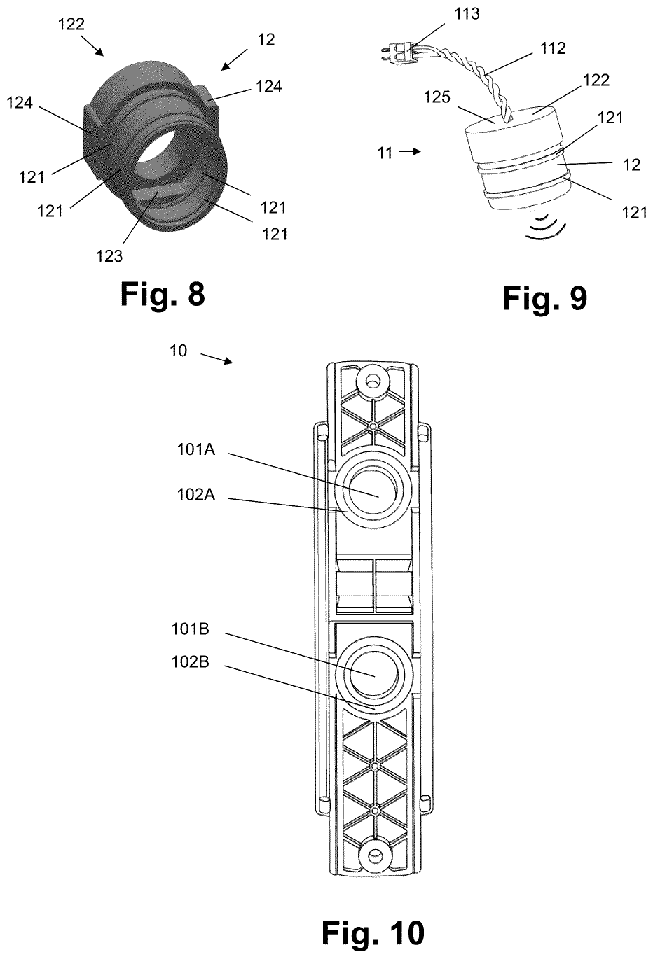

That being said, the ultrasonic transducer 11, 11A, 11B has at least an electrical connection (e.g., by way of a twisted pair cable 112 as shown in FIG. 8) with another part of the flowmeter 1, for example a circuit board 15. In another example, the ultrasonic transducer 11, 11A, 11B is mechanically and electrically connected to the flowmeter 1, in particular the circuit board 15, by way of two electrical pins.

In the following description, reference is made primarily to reflection paths R1, R2, via one or more reflection points P1, P21, P22; nevertheless, one skilled in the art will understand that a plurality of paths, for measuring the transit times of ultrasonic pulses propagating at least partly in and against flow direction f, can be implemented using a plurality of direct paths D1, a plurality of reflection paths R1, R2, or a combination of one or more direct paths D1 and one or more reflection paths R1, R2. Preferably, at least one path is a reflection path R1, R2.

In an embodiment, a damper system 4 is arranged in the channel 2. As illustrated in FIGS. 3 to 6, the damper system 4 comprises a damper blade 40 which is arranged inside the channel 2, rotatable about a rotation axis r to adjust the orifice of the channel 2 and thereby regulate the flow Φ of fluid through the channel 2. The damper system 4 and its damper blade 40 are arranged in the channel 2 downstream of the ultrasonic flowmeter 10 and its ultrasonic transducers 11, 11A, 11B. The rotation axis r of the damper blade 4 divides the cross section of the channel 2 into two halves H1, H2.

As illustrated in FIGS. 4, 5, in one of the two halves H1, herein defined as the upper half H1, the damper blade 40 is movable downstream in flow direction f. In the other one of the two halves H2, herein defined as the lower half H2, the damper blade 40 is movable upstream u against the flow direction f. The ultrasonic transducers 11A, 11B are arranged on the same side of the channel 2 forming either of the two halves H1, H2.

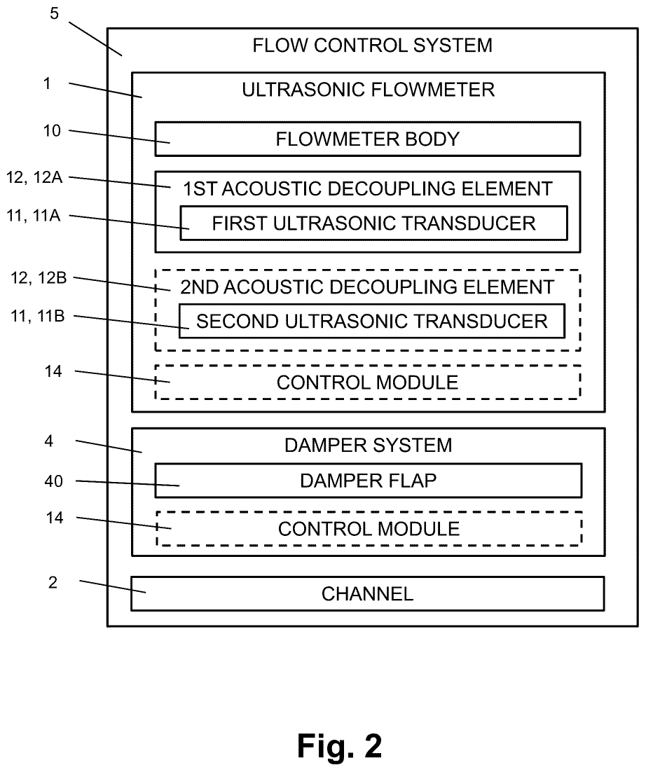

In the embodiments illustrated in FIG. 5, the ultrasonic transducers 11A, 11B are arranged on the side of the channel 2 which forms the lower half H2, i.e. the side where the damper blade 40 is movable upstream u against the flow direction f. Preferably, the ultrasonic transducers 11A, 11B are arranged on the side of the channel 2 which forms the upper half H1, i.e. the side where the damper blade 40 is movable downstream in the flow direction f, as illustrated in FIGS. 2, 4, and 6. Naturally, the damper blade 40 is also movable in the opposite direction in order to restrict the flow f.

In FIGS. 3 to 7, reference numeral 5 refers to a flow control system, also referred to as a variable air volume (VAV) system (also referred to as “VAV device” or “VAV box”) for heating, ventilating, and air conditioning (HVAC), which flow control system 5 comprises the ultrasonic flowmeter 1 and the damper system 4. The flow control system 5 controls the air volume on a given setpoint that is typically received from an external device or system. The setpoint can be derived from any mathematical combination of the temperature and/or measured flow in the supply and/or return air (and in the room (e.g. from a room sensor)). The room sensor can include a temperature, humidity, and/or CO2 sensor.

As illustrated in FIGS. 3, 4, the ultrasonic transducers 11A, 11B are arranged on the same side of the channel 2, along a longitudinal arrangement axis a, which runs parallel to the central axis of the channel 2.

As illustrated in FIGS. 3-5, the ultrasonic transducer 11B arranged downstream in the flow direction f is arranged at a defined distance L to the damper blade 40. More specifically, the ultrasonic transducer 11B is arranged at a distance L between its center axis c and a cross sectional plane q/r which runs through the damper blade 40 in closed position. Preferably, the defined distance L from the downstream ultrasonic transducer 11B is within a range of 75% to 250%, more preferably in a range from 140% to 200% of the diameter D of the channel 2.

In an embodiment, the ultrasonic transducers 11A, 11B are arranged asymmetrically with respect to a transverse centreline b of the flowmeter 1, in particular the flowmeter body 10. In particular, the ultrasonic transducer 11B downstream in flow direction f is arranged to be closer to the centreline b of the flowmeter 1 than the ultrasonic transducer 11A upstream in flow direction f. This has the benefit of allowing the flowmeter 1 to be mounted closer to the damper system 4 while still maintaining the distance L between the downstream flowmeter 11B and the damper blade 40. This results in a more compact flow control system 1, such that the flow control system 1 can be installed in more space constrained places.

In a further embodiment, the damper system 40 comprises a damper actuator 3 with an electric motor coupled to the damper blade 40 to drive the damper blade 40 in all possible positions between open and closed positions, thereby regulating the flow of the fluid in the channel 2.

As illustrated in FIGS. 1-5, the flow measurement system 1 further comprises a control module 14 connected to the ultrasonic transducers 11, 11A, 11B of the ultrasonic flowmeter 10. As indicated in FIGS. 1-5, the control module 14 is arranged in the ultrasonic flowmeter 10, e.g. in a common housing together with the ultrasonic transducers 11A, 11B, or external to the ultrasonic flowmeter 10, separate from the ultrasonic transducers 11, 11A, 11B, e.g. in or on a housing of an actuator 3 of the damper system 4. In an embodiment, the control module 14 is connected to the actuator 3 of the damper system 4 for controlling operation of the actuator 3 or its electric motor, respectively, such as to drive the damper blade 40 to adjust the orifice of the channel 2 and control the flow Φ of fluid through the channel 2.

The control module 14 comprises an electronic circuit and is configured to perform various functions and steps as described below in more detail. Depending on the embodiment, the electronic circuit of the control module 14 is controlled by a software program code stored on a computer-readable non-transitory computer medium, the electronic circuit may comprise an application specific integrated circuit (ASIC), and/or the electronic circuit comprises discrete electronic components.

As illustrated in FIGS. 3-5, the ultrasonic transducers 11, 11A, 11B of the ultrasonic flowmeter 10, are arranged and configured not only to emit ultrasonic pulses into the channel 2, but also to receive reflections of ultrasonic pulses from reflection points P1, P21, P22, on the inside wall 20 of the channel 2 and propagating along respective reflection paths R1, R2. FIGS. 3-5 illustrate a reflection path R1 of an ultrasonic pulse with a single reflection, at a single reflection point P1 on the inside wall 20 of the channel 2, and a reflection path R2 of the ultrasonic pulse with twofold reflection R2, at two reflection points P21, P22 on the inside wall 20 of the channel 2. Nevertheless, further reflection paths of ultrasonic pulses with three- or more reflections on three or more reflection points on the inside wall 20 of the channel 2 may be detected by the receiving ultrasonic transducer 11, 11A, 11B as emitted by the emitting ultrasonic transducer 11, 11A, 11B of the ultrasonic flowmeter 10.

The control module 14 or its electronic circuit, respectively, is configured to control the ultrasonic transducers 11, 11A, 11B to emit the one or plurality of ultrasonic pulse(s).

The control module 14 or its electronic circuit, respectively, is further configured to receive from the ultrasonic transducers 11, 11A, 11B reflections of the one of plurality of ultrasonic pulse(s) detected by the respective ultrasonic transducers 11, 11A, 11B.

The control module 14 or its electronic circuit, respectively, is further configured to determine and store the transit times of the ultrasonic pulses propagating along the reflection paths R1, R2, from the emitting ultrasonic transducer 11, 11A, 11B to the receiving ultrasonic transducer 11, 11A, 11B, via the one or more reflection points P1, P21, P22, on the inside wall 20 of the channel 2.

The control module 14 or its electronic circuit, respectively, is further configured to determine the flow of fluid (e.g., the flow of gas Φ) using downstream transit times t_{down} of ultrasonic pulses propagating in flow direction f and upstream transit times tᵤₚ of ultra-sonic pulses propagating against flow direction f, along one or more reflection paths R1, R2, via one or more reflection points P1, P21, P22, on the inside wall 20 of the channel 2. Specifically, the flow of gas Φ is determined from the average velocity of an ultrasonic pulse on a particular reflection path R1, R2, by averaging the time differences in the respective downstream transit time t_{down} and upstream transit times tᵤₚ of the ultrasonic pulse propagating along the particular reflection path R1, R2, from the emitting ultrasonic transducer 11, 11A, 11B to the receiving ultrasonic transducer 11, 11A, 11B. The flow of fluid Φ is for example the volume flow in m³/h or the mass flow in kg/sec.

For increased accuracy, the control module 14 or its electronic circuit, respectively, is configured to determine the flow of gas Φ using the downstream transit times t_{down} and the upstream transit times tᵤₚ of ultrasonic pulses along more than one reflection paths R1, R2, e.g. along a reflection path R1, with a single reflection at one reflection point P1, and along one or more further reflection paths R2 with multiple reflections at more than one reflection point P21, P22. For example, the velocity or flow Φ of fluid determined from measurements of downstream and upstream transit times t_{down}, tᵤₚ of ultrasonic pulses along multiple reflection paths R1, R2, are averaged. In an embodiment, a (weighted) average is used, for example using correction or weighting factors derived from the flow profile of the channel 2. For the latter example, the control module 14 or its electronic circuit, respectively, is configured to determine the flow profile in the channel 2, e.g. a laminar, Poiseuille, turbulent or another flow profile, from the transit times of ultrasonic pulses measured via a plurality of different paths R1, R2, in the channel 2. In an embodiment, the control module 14 or its electronic circuit, respectively, is configured to use the determined flow profile for determining the flow Φ of fluid, e.g. by multiplying the determined flow Φ (or the measurements of the transit times) by a correction factor dependent on the determined flow profile.

In an embodiment, the control module 14 or its electronic circuit, respectively, is configured to determine the flow Φ of fluid further using the signal strengths of the detected reflections, i.e. the signal strengths of the ultrasonic pulses received and detected by the ultrasonic transducers 11, 11A, 11B via the reflection paths R1, R2.

For example, the control module 14 or its electronic circuit, respectively, is configured to exclude the transit times of ultrasonic pulses received via a particular reflection path R1, R2, from determining the flow Φ of fluid, if a signal strength value of the particular reflection is below a set threshold value, indicative of fouling by dirt or debris deposited at the location of the respective reflection point P1, P21, P22. In an embodiment, the control module 14 or its electronic circuit, respectively, is configured to generate an alarm, if the signal strength of the ultrasonic pulses received via all the paths is below a defined threshold, e.g. set to 25% of the signal strength value of the ultrasonic pulse emitted by the respective ultrasonic transducer 11, 11*, 11A, 11B. For example, the alarm is sent to an operator via a wired or wireless communication network.

Alternatively or in addition, the control module 14 or its electronic circuit, respectively, is configured to determine the flow Φ of fluid using an average of the transit times or their contribution to the determining the flow Φ of fluid, respectively, e.g. further applying a correction factor determined from the flow profile in the channel 2.

In an embodiment, the control module 14 may be configured to detect a reverse flow of fluid and to generate an alarm if a reverse flow of fluid in the channel 2 is detected.

The control module 14 may be configured to regulate the flow of fluid. This is achieved by moving the damper blade 40 to alter the flow of the fluid in the channel 2 until a measured flow of the fluid is equal to, or within a tolerance range, of a defined setpoint. The setpoint may be defined using a message received from an input, such as a digital or analog input of the flow control system 5, in particular the flowmeter 1. The setpoint may relate to a flow velocity, a volumetric flow, and/or a heat flow of the fluid.

The flowmeter 1 may additionally include one or more status indicators, in particular in the form of one or more LEDS configured to indicate, via a particular colour of the LED and/or via one or more flash patterns, a status of the flowmeter 1. In particular, the power supply status and communication status may be indicated.

In an embodiment, the control module 14 is further configured to receive, from the damper system 4, a blade position of the damper blade 40. The damper system 4 can be operated in ‘slave’ mode, i.e. with the flowmeter 1 controlling the damper system 4, in particular the damper blade 40. Preferably, the control module 14 controls the blade position of the damper blade 40 in a closed loop control. Additionally, the control module 14 may be configured to compensate signals received by the ultrasonic transducers 11, 11A, 11B, depending on the blade position, using a compensation curve stored in the control module 14 as part of the calibration parameters. As discussed herein, the calibration parameters can be adjusted. This can allow for a reduction of the distance L between the downstream ultrasonic sensor 11B and the damper blade 40, allowing for a more compact flow measurement system 4.

The control module 14 further comprises a wireless communication module configured for short-range wireless communication, in particular using RFID e.g. NFC and/or Bluetooth. The control module 14 is configured to receive data from, and/or transmit data to, a mobile communication device (e.g., a smart phone), via the wireless communication module. The data received from the mobile communication device comprises, for example, configuration parameters and/or calibration parameters. The configuration parameters related to the commissioning of the flowmeter 1 and/or the damper system 4, for example. The calibration parameters are related to the sensor calibration, for example. The data transmitted to the mobile communication device comprises, for example, the configuration parameters and/or the calibration data, but may also include device identification information of the flowmeter 1 and/or the damper system 4, including, for example, a device serial number and/or a device type.

The flow control system 5, in particular the flowmeter 1 and/or the damper system 4, may further be configured to measure additional parameters beyond a flow velocity of the fluid. The flow control system 5 may measure these additional parameters using the ultrasonic transducers 11, 11A, 11B, (for example, the speed of sound in the fluid may be determined using the transit times), or comprise additional sensors, such as a temperature sensor, humidity sensor, and/or CO2 sensor. Using these additional sensors, not only the directly measured parameters may be provided, e.g. temperature. humidity, and/or and CO2 concentration in the fluid, but also parameters derived therefrom, including in particular a heat flow in the fluid. In an embodiment, the flow control system 1, in particular the flowmeter 1, includes an additional temperature output interface (i.e. an analog and/or digital interface).

The control module 14 may be further configured with a counter function, which may be configured to record various measurement parameters over time, in particular a cumulative volume/mass of fluid flow.

As shown in FIGS. 1, 2, 6, 7, 8, 10 least one of the ultrasonic transducers 11, 11A, 11B of the ultrasonic flowmeter 1 is attached to the flowmeter body 10 by way of an acoustic decoupling element 12, 12A, 12B. Preferably, each ultrasonic transducer 11, 11A, 11B are attached to the flowmeter body 10 by way of an acoustic decoupling element 12, 12A, 12B.

The acoustic decoupling elements 12, 12A, 12B are designed to attenuate sound waves passing through the acoustic decoupling element 12, 12A, 12B, in particular sound waves in the ultrasonic frequency range, that is, above 20 kHz. Preferably, the acoustic decoupling element 12, 12A, 12B has an acoustic impedance dissimilar to the acoustic impedance of any part of the flowmeter 1 touching the acoustic decoupling element 12, 12A, 12B. These parts include the ultrasonic transducers 11, 11A, 11B and the flowmeter body 1, in particular. Further, these parts may include a circuit board of the flowmeter 1, wherein the ultrasonic transducers 11, 11A, 11B are connected to the circuit board.

By attenuating the sound waves, the acoustic decoupling elements 12, 12A, 12B decrease the noise detected by an ultrasonic transducer 11, 11A, 11B when receiving an ultrasonic pulse from the channel.

Preferably, the acoustic decoupling elements 12, 12A, 12B are made from an elastic material, for example rubber or silicone.

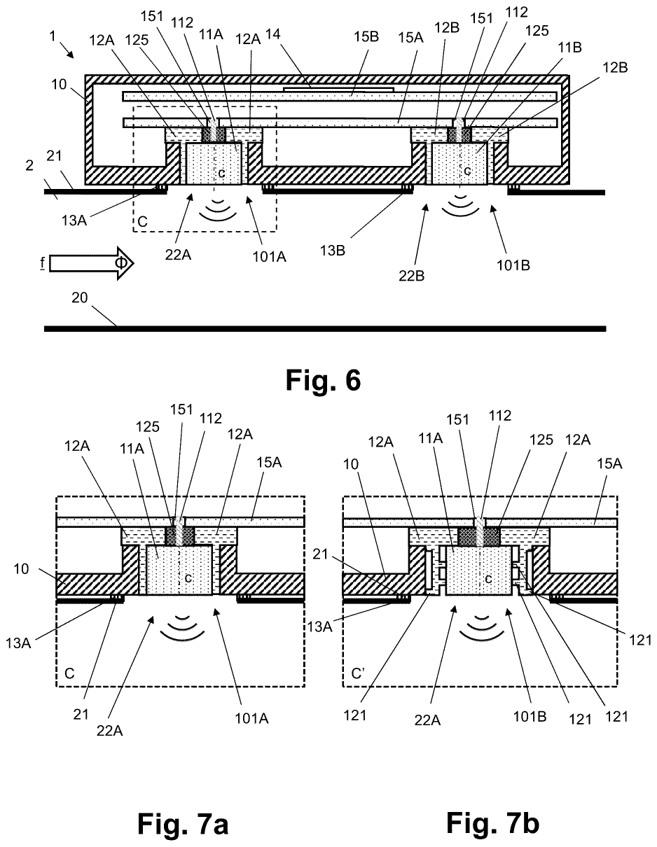

As illustrated particularly in FIG. 6, the flowmeter 1 is mounted to the channel 2, in particular being attached to an outside wall 21 of the channel 2. The outside wall 21 of the channel has channel openings 22A, 22B, preferably circular openings, where the flowmeter 1 is mounted such that the ultrasonic transducers 11A, 11B of the flowmeter 1 emit and receive ultrasonic pulses, through the channel openings 22A, 22B into and from the channel 2, respectively.

The flowmeter 1 has a flowmeter body 10 which is designed to house the components of the flowmeter 1. In particular, the flowmeter body 10 comprises one or more printed circuit boards 15, 15A, 15B, which comprises electrical traces and are designed to electrically connect the ultrasonic transducers 11A, 11B to the various electronic components of the flowmeter 1, in particular the control module 14. Further electronic components, including electronics for providing power to the various components of the flowmeter 1 and optionally also the damper system 4, are not shown for the sake of simplicity. Further electronic components may also include protection circuitry to protect the electronic components of the flowmeter 1 and/or the damper system 4 from electrostatic discharge. The ultrasonic transducers 11A, 11B can be connected to at least one of the circuit boards 15A, 15B by one or more wires and/or connectors (not shown).

In an embodiment, the flowmeter 1 comprises two circuit boards 15A, 15B, as shown in FIG. 6. A first circuit board 15A is preferably arranged adjacent to the ultrasonic transducers 11A, 11B and includes analog circuitry and/or digital circuity, in particular related to the ultrasonic transducers 11A, 11B. For example, the first circuit board 15A comprises the circuitry necessary for transmitting and receiving the ultrasonic pulses from the ultrasonic transducers 11A, 11B, as well as digital signal processing of the ultrasonic pulses. The second circuit board 15B preferably includes parts related to the control module 14 and is configured to carry out at least some of the steps and/or functions described herein. The second circuit board 15B further includes circuity for communication, in particular the wireless communication module, and is further configured for data communication using a data bus. The reverse arrangement is also possible.

The circuit board 15, preferably the first circuit board 15A, has one or more openings 151. Each opening 151 is adjacent to a particular ultrasonic transducer 11, 11A, 11B, such that a cable 112, preferably a twisted pair cable 112 connected to the particular ultrasonic transducer 11, 11A, 11B can pass through the circuit board 15 for electrically connecting the particular ultrasonic transducer 11, 11A, 11B to a plug or socket attached to a side of the circuit board 15 opposite to the particular ultrasonic transducer 11, 11A, 11B.

The space between the ultrasonic transducers 11, 11A, 11B, the acoustic decoupling element 12, 12A, 12B, and the circuit board 15A is preferably filled with a curable potting material 125.

The flowmeter body 10 has two ultrasonic transducer openings 101A, 101B, preferably circular openings, configured to receive the ultrasonic transducers 11A, 11B as attached to the acoustic decoupling elements 12A, 12B. The ultrasonic transducer openings 101A, 101B serve to allow the ultrasonic pulses to be emitted into the channel 2 and received from the channel 2.

The ultrasonic transducers 11A, 11B are designed to emit ultrasonic pulses into the channel, however it is unavoidable that at least some sonic energy of the emitted and/or received ultrasonic pulses is coupled into the flowmeter body 10. This sonic energy is transmitted by the flowmeter body 10 from the emitting ultrasonic transducer 11A to the receiving ultrasonic transducer 11B, or the received ultrasonic pulse is coupled into the flowmeter body 10 in proximity of the ultrasonic transducer 11, 11A, 11B, and from there into the ultrasonic transducer 11, 11A, 11B, leading to a reduced signal to noise ratio. The acoustic decoupling elements 12A, 12B attenuate the signal both by absorbing the sonic energy and, due to the abrupt change in acoustic impedance caused by the strong difference in material properties between the acoustic decoupling elements 12A, 12B and the flowmeter body 10, and between the acoustic decoupling elements 12A, 12B and the ultrasonic transducers 11A, 11B, also reflect sonic energy.

As depicted, the acoustic decoupling elements 12A, 12B are cylindrically shaped (e.g., ring-cylindrically shaped, sleeve shaped) and designed to achieve a form fit with the ultrasonic transducers 11A, 11B, which are typically also cylindrically shaped. The acoustic decoupling elements 12A, 12B additionally may have a base part 122 which extends radially inwards towards a cylinder axis c of the cylinder shape, and optionally also extends radially outwards away from the cylinder axis c. A bottom of the base part 122 abuts against the circuit board 15 and thereby also provides a convenient way of mounting the ultrasonic transducers 11A, 11B in the flowmeter body 10.

The acoustic decoupling elements 12A, 12B further serve to seal the flowmeter body 10 against fluid (e.g., gas) ingress.

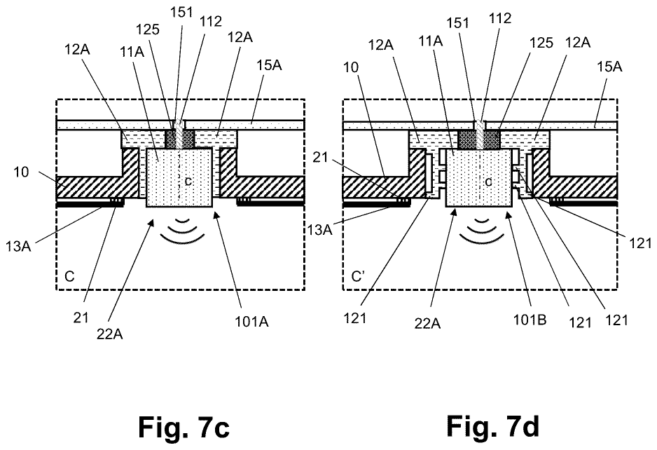

The ultrasonic transducers 11, 11A, 11B are, in an embodiment, arranged such that they extend out of the flowmeter body 10, in particular into the channel 2, as shown in FIGS. 7a, 7b. For example, the ultrasonic transducers 11, 11A, 11B are configured to extend 1 mm-10 mm, preferably 1 mm-5 mm, out of the flowmeter body 10. Preferably, the ultrasonic transducers 11, 11A, 11B are configured to extend out of the flowmeter body 10, such that the emitting surface of the ultrasonic transducer extends into the channel by 0-5 mm, preferably 0-2 mm.

FIGS. 6, 7a, 7b, 7c and 7d also show optional sealing elements 13A, 13B which are arranged on the outside of the flowmeter body 10 around the ultrasonic transducer openings 101A, 101B in the flowmeter body 10. The sealing elements 13A, 13B seal the flowmeter body 10 against the channel 2 such that no fluid can leak out of the openings 22A, 22B. Additionally, the sealing elements 13A, 13B further acoustically isolate the flowmeter body 10 from the channel 2, thereby reducing any sonic energy transferred between the ultrasonic transducers 11A, 11B via the channel 2. This further attenuates any sonic energy traveling between the flowmeter body 10 and the channel 2.

In an embodiment, the sealing elements 13A, 13B are ring-shaped and centered on the ultrasonic transducers 11A, 11B. The sealing elements 13A, 13B are preferably mounted/arranged in recesses 102A, 102B of the flowmeter body 10 (as shown in FIG. 10) with a shape at least partially complementary to the sealing elements 13A, 13B. The sealing elements 13A, 13B are preferably made of an elastomer.

In an embodiment, the sealing elements 13A, 13B are co-molded with the flowmeter body 10.

FIG. 7a shows a detailed view of the area C of FIG. 6. FIG. 7b shows an alternate embodiment of area C of FIG. 6 (not shown in FIG. 6) in which the acoustic decoupling element 12 has transverse ribs 121 such that there are air gaps between the flowmeter body 10 and the acoustic decoupling element 12, and between the acoustic decoupling element 12 and the ultrasonic transducer 11. The air gaps further increase the noise isolation.

In an embodiment, the acoustic decoupling element 12 comprises a foam, which has a plurality of enclosed air pockets and also forms small air gaps on the inner and/or outer surface when installed.

The flowmeter 1 comprises an input cable connected to the flowmeter body 10 by way of an attachment mechanism configured to slidably engage with the flowmeter body 10 to secure the input cable. The input cable is configured to provide power to the flowmeter 1 (e.g., a two wire power supply include a 24 V supply AC or DC power supply, and GND). The input cable further includes one or more data wires for controlling the flowmeter 1 and/or the damper system 4.

Signals are received in, and transmitted by, the flowmeter 1 over the data wire(s). The signals may include analog and/or digital signals.

Depending on the embodiment, input signals may be received as analog and/or digital signals, while output signals may be transmitted as analog and/or digital signals.

The analog signals are, for example, a variable voltage (e.g., 0 V to 10 V, or 2 V to 10 V).

The digital signals are preferably communicated using a data bus. The data bus is, for example, a Modbus RTU (RS485), a BACnet MS/TP (RS485), or a MP-Bus.

Additionally, the flowmeter 1 comprises a damper system connection cable configured to provide power and control signals to the damper system 4.

In an embodiment, the ultrasonic transducers 11, 11A, 11B are arranged such that they extend out of the acoustic decoupling elements 12, 12A, 12B, in particular in direction of the channel 2, as shown in FIGS. 7c, 7d. For example, the ultrasonic transducers 11, 11A, 11B are arranged such that they extend 1 mm to 10 mm, preferably 2 mm-5 mm, most preferably 2 mm, out of the acoustic decoupling elements 12, 12A, 12B.

Preferably, the ultrasonic transducers 11, 11A, 11B are arranged such that they extend out of the acoustic decoupling elements 12, 12A, 12B, such that, when the flowmeter is installed, a bottom end of the ultrasonic transducer, i.e. the emitting surface of the ultrasonic transducer, is flush with an inner wall of the channel or extends into the channel 2, preferably by a distance of up to 10 mm, preferably 5 mm.

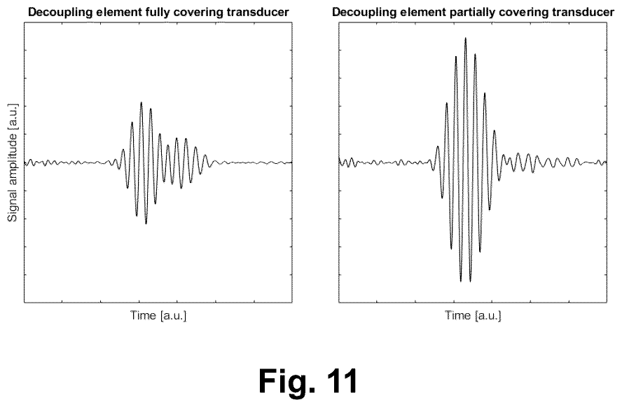

Having the ultrasonic transducers 11, 11A, 11B arranged such that they extend out of the acoustic decoupling elements 12, 12A, 12B provides the positive effect of improved signal quality (e.g., relating to the overall signal to noise ratio, the envelope flank steepness, signal rise and fall time, signal shortness, etc.), as shown in FIG. 11 described below.

In an embodiment, as illustrated in FIG. 8, the acoustic decoupling element 12, 12A, 12B has one or more inner alignment elements 123. These inner alignment elements 123 are, for example, one or more protrusions and/or recesses and/or a step on an inner surface at a defined angular position (i.e., defined by a particular polar angle with respect to the cylinder axis c).

The one or more inner alignment element(s) 123 are designed to mechanically cooperate with an at least partially complementary alignment element on an outer surface of the ultrasonic transducer 11A, 11B (e.g., a recess or protrusion, respectively), such that the ultrasonic transducer 11A, 11B has a defined angular position (in particular, a defined polar angle) with respect to the acoustic decoupling element 12A, 12B.

Additionally, the acoustic decoupling element 12A, 12B has one or more outer alignment elements 124. These outer alignment elements 124 are, for example, one or more protrusions and/or recesses on an outer surface at a defined angular position. These outer alignment elements 124 are designed to cooperate with an at least partially complementary alignment element of the flowmeter body 10 (e.g., a recess and/or protrusion, respectively), such that, ultimately, the ultrasonic transducer 11A, 11B has a defined angular position (in particular, a defined polar angle) with respect to the flowmeter body 10. This is beneficial in particular in cases where the ultrasonic transducer 11A, 11B has an asymmetric polar radiation characteristic.

As illustrated in FIG. 9, the ultrasonic transducer 11 is arranged inside the acoustic decoupling element 12 such that when it is mounted in the flowmeter 1, it is held in place solely by the acoustic decoupling element 12, such that there is no direct mechanical connection between the flowmeter body 10 and the ultrasonic transducer 11. The transverse ribs 121 are circular protrusions on the outside (and optionally also on the inside) of the acoustic decoupling element 121 which further reduce the area of contact between the acoustic decoupling element 12 and the flowmeter body 10 (and for inside ribs, between the acoustic decoupling element 12 and the ultrasonic transducer 11. The acoustic decoupling element 12 has a cylindrical shape with a base part 122.

In an embodiment in which a particular acoustic decoupling element 12 has transverse ribs 121 on the inside and on the outside, it is preferable that a given transverse rib 121 on the inside not have a corresponding transverse rib 121 on the outside at the same position relative to the centerline c. In other words, the transverse ribs 121 on the inside and outside are longitudinally (i.e. in the direction of the center line c) displaced relative to each other.

Depending on the embodiment, the base part 122 may comprise a potting material 125 introduced into a recess formed after inserting the ultrasonic transducer 11 into the cylindrically shaped part of the acoustic decoupling element 11. The potting material 125 is preferably silicone and prevents an axial movement of the ultrasonic transducer 11 along the central axis c.

The ultrasonic transducer 11 is connected to the circuit board 15 by way of a twisted pair cable 112 and a plug 113.

As shown in FIG. 10, the bottom of the flowmeter body 10 is, on the whole, flat and substantially rectangular and includes two ultrasonic transducer openings 101A, 101B. Annular recesses 102A, 102B for the sealing elements 13A, 13B are arranged centered on the ultrasonic transducer openings 101A, 101B with a diameter larger than the ultra-sonic transducer openings 101A, 101B.

FIG. 11 shows the recorded signal of a transmitted signal of a certain amplitude at an exit angle of 0° from the ultrasonic transducers 11, 11A, 11B for two different relative extensions of the ultrasonic transducers 11, 11A, 11B from the acoustic decoupling elements 12, 12A, 12B, respectively. The left plot shows the signal amplitude in the scenario where the acoustic decoupling element 12, 12A, 12B is flush with the ultrasonic transducers 11, 11A, 11B. The right plot shows the signal amplitude in the scenario where the ultrasonic transducers 11, 11A, 11B extend out of the acoustic decoupling elements 12, 12A, 12B by 2 mm. The signal quality of the recorded signal is higher in the right hand plot, that is, the signal quality is improved if the ultrasonic transducers 11, 11A, 11B extend out of the acoustic decoupling elements 12, 12A, 12B, in that the peak amplitude is increased, the envelope flanks are steeper, and the overall signal duration is shorter (which allows for a more precise determination of signal arrival time).

The above-described embodiments of the disclosure are exemplary and the person skilled in the art knows that at least some of the components and/or steps described in the embodiments above may be rearranged, omitted, or introduced into other embodiments without deviating from the scope of the present disclosure.

1. An ultrasonic flowmeter for measuring a flow of fluid through a channel, the ultrasonic flowmeter comprising
a flowmeter body, and
at least two ultrasonic transducers attached to the flowmeter body,
the at least two ultrasonic transducers being configured to emit an ultrasonic pulse into the channel and to receive an ultrasonic pulse in the channel, and
the at least two ultrasonic transducers being arranged at a distance from each other in flow direction, when the flowmeter body is fixed to the channel,
wherein at least one ultrasonic transducer of the at least two ultrasonic transducers is attached to the flowmeter body by an acoustic decoupling element.

2. The ultrasonic flowmeter of claim 1, wherein the acoustic decoupling element has a cylindrical shape, which encloses at least partially the at least one ultrasonic transducer.

3. The ultrasonic flowmeter of claim 1, wherein there is at least one air gap between one or more of: at least part of the particular acoustic decoupling element and the ultrasonic transducer, or between at least part of the particular acoustic decoupling element and the flowmeter body.

4. The ultrasonic flowmeter of claim 3, wherein the at least part of the particular acoustic decoupling elements includes protrusions on an inner surface and/or an outer surface of the particular acoustic decoupling element.

5. The ultrasonic flowmeter of claim 1, wherein the acoustic decoupling elements comprises an elastomer or a thermoplastic or thermosetting polymer.

6. The ultrasonic flowmeter of claim 1, wherein the ultrasonic flowmeter includes a circuit board and the acoustic decoupling elements abuts against the circuit board.

7. The ultrasonic flowmeter of claim 1, wherein the at least two ultrasonic transducers have a central axis and at least one of the at least two ultrasonic transducers has an asymmetric polar radiation characteristic with respect to the central axis,
wherein an inner surface of the acoustic decoupling element is configured to cooperate with an outer surface of the corresponding ultrasonic transducer, and
wherein an outer surface of the acoustic decoupling element is configured to cooperate with the flowmeter body, such that the corresponding ultrasonic transducer has a predefined polar angle with respect to the flowmeter body.

8. The ultrasonic flowmeter of claim 1, wherein the flowmeter body comprises at least one sealing element arranged around at least one of the at least two ultrasonic transducers, the at least one sealing element being configured to seal between the ultrasonic flowmeter and the channel when the ultrasonic flowmeter is fixed to the channel.

9. The ultrasonic flowmeter of claim 8, wherein the at least one sealing element is an injection molded thermosetting or thermoplastic polymer.

10. The ultrasonic flowmeter of claim 1, wherein the at least two ultrasonic transducers are arranged asymmetrically with respect to a transverse centerline of the flowmeter body.

11. The ultrasonic flowmeter of claim 1, further comprising a control module configured to determine and store transit times of ultrasonic pulses propagating in and against the flow direction along more than one path between the at least two ultrasonic transducers, and to determine the flow of fluid using the transit times.

12. A flow control system comprising:
a channel,
a damper system having a damper flap arranged in the channel, and
the ultrasonic flowmeter according to claim 1,
wherein the ultrasonic flowmeter is fixed to the channel and arranged upstream of the damper system.

13. The flow control system of claim 12, further comprising a control module configured to determine and store transit times of ultrasonic pulses propagating in and against the flow direction along more than one path in the channel, and to determine the flow of fluid using the transit times.

14. The flow control system of claim 13, wherein the control module is further configured to receive a flow setpoint and to control a damper actuator according to the flow setpoint and the determined flow of fluid to reach the flow setpoint.

15. The flow control system of claim 12, wherein the control module is arranged in the damper system in the ultrasonic flowmeter, or is arranged as a separate device connected to the damper system and the ultrasonic flowmeter.

16. The ultrasonic flowmeter of claim 9, wherein the at least one sealing element is co-molded with the flowmeter body.
